(19) United States
(12) Patent Application Publication
(10) Pub. No.: US 2019/0317795 A1
(43) Pub. Date: Oct. 17, 2019

(54) MEMORY ACCESS METHOD FOR USE IN MULTI-OPERATING SYSTEMS AND ELECTRONIC DEVICE

(71) Applicant: CLOUDMINDS (SHENZHEN) ROBOTICS SYSTEMS CO., LTD., Shenzhen (CN)

(72) Inventor: Xiangxiao KONG, Shenzhen (CN)

(21) Appl. No.: 16/453,055

(22) Filed: Jun. 26, 2019

Related U.S. Application Data
(63) Continuation of application No. PCT/CN2016/112489, filed on Dec. 27, 2016.

(51) Int. Cl. G06F 9/455; G06F 9/54; G06F 9/50

(52) U.S. Cl. CPC G06F 9/45558; G06F 2009/45583; G06F 9/5016; G06F 9/54

(57) ABSTRACT

A memory access method for use in multi-operating systems includes: in a guest operating system, requesting to share a memory from a host operating system when it is monitored that software needs to share the memory; in the host operating system, allocating a memory share sub-region to the guest operating system by a memory share management module Gralloc; in the host operating system, returning an index value of the memory share sub-region to the guest operating system; and in the guest operating system, returning an address of a mapping sub-region to the software upon mapping the memory share sub-region corresponding to the index value to the guest operating system by an emulation processor QEMU.

### CROSS-REFERENCE TO RELATED APPLICATIONS

This application is a continuation of International Application No. PCT/CN2016/112489, with an international filing date of Dec. 27, 2016, the entire contents of which are incorporated herein by reference.

### TECHNICAL FIELD

The present application relates to the field of virtualization technologies, and in particular, relates to a memory access method for use in multi-operating systems and an electronic device.

### BACKGROUND

Graphic memory allocator (Gralloc) is a management module for a shared memory developed by Google for dedicated use in an Android display system. The shared memory specifically refers to a memory region that features a continuous physical address and supports a direct memory access (DMA) device. This memory region may be directly accessed by a graphics processing unit (GPU), a visual processing unit (VPU), a camera or the like device, and may also be used as a texture of an open graphics library (OpenGL) for rendering.

By the Gralloc, different modules may share a memory, and the shared memory supports direct access of the DMA device, with no need of copying and processing by a central processing unit (CPU). This greatly reduces a load ratio of the CPU, such that utilization rate and parallel processing capabilities of the CPU are significantly improved.

### SUMMARY

An embodiment of the present application provides a memory access method for use in multi-operating systems. The method includes: in a guest operating system, requesting to share a memory from a host operating system when it is monitored that software needs to share the memory; in the host operating system, allocating a memory share sub-region to the guest operating system by a memory share management module Gralloc; in the host operating system, returning an index value of the memory share sub-region to the guest operating system; and in the guest operating system, returning an address of a mapping sub-region to the software upon mapping the memory share sub-region corresponding to the index value to the guest operating system by an emulation processor QEMU.

Another embodiment of the present application provides an electronic device. The electronic device includes: a memory, and at least one processor; wherein the memory is communicably connected to the at least one processor via a communication bus; the at least one processor is configured to perform instructions stored in the memory; and the memory stores instructions for performing the steps of: in a guest operating system, requesting to share a memory from a host operating system when it is monitored that software needs to share the memory; in the host operating system, allocating a memory share sub-region to the guest operating system by a memory share management module Gralloc; in the host operating system, returning an index value of the memory share sub-region to the guest operating system; and in the guest operating system, returning an address of a mapping sub-region to the software upon mapping the memory share sub-region corresponding to the index value to the guest operating system by an emulation processor QEMU.

Still another embodiment of the present application provides a computer program product for use in combination with an electronic device. The computer program product includes: a computer program embedded into a computer-readable storage medium; wherein the computer program includes instructions for causing the electronic device to perform the steps of: in a guest operating system, requesting to share a memory from a host operating system when it is monitored that software needs to share the memory; in the host operating system, allocating a memory share sub-region to the guest operating system by a memory share management module Gralloc; in the host operating system, returning an index value of the memory share sub-region to the guest operating system; and in the guest operating system, returning an address of a mapping sub-region to the software upon mapping the memory share sub-region corresponding to the index value to the guest operating system by an emulation processor QEMU.

### BRIEF DESCRIPTION OF THE DRAWINGS

Specific embodiments of the present application are described hereinafter in detail with reference to the accompanying drawings.

FIG. 1 is a schematic structural diagram of a system using a memory access method for use in multi-operating systems according to an embodiment of the present application;

FIG. 2 is a flowchart of a memory access method for use in multi-operating systems according to an embodiment of the present application;

FIG. 3 is a flowchart of another memory access method for use in multi-operating systems according to an embodiment of the present application;

FIG. 4 is a schematic structural diagram of a memory access apparatus for use in multi-operating systems according to an embodiment of the present application; and

FIG. 5 is a schematic structural diagram of an electronic device according to an embodiment of the present application.

### DETAILED DESCRIPTION

For clearer descriptions of the technical solutions and advantages of the present application, exemplary embodiments of the present application are described in detail hereinafter with reference to the accompanying drawings. Apparently, the described embodiments are merely a part of embodiments of the present application, instead of all the embodiments of the present application. It should be noted that in cases of no conflict, the embodiments and features in the embodiments of the present application may be combined together.

The applicant has identified in practice of the present application:

Gralloc may enable different modules to simultaneously access the same memory, and access to the memory also supports a direct access by a DMA device and thus copying by a CPU is not needed. This greatly reduces a load ratio of the CPU, such that utilization rate and parallel processing capabilities of the CPU are significantly improved. However, with respect to a virtual operating system, no feasibly solution for Gralloc virtualization is provided currently.

Accordingly, the present application provides a memory access method for use in multi-operating systems. The memory access method includes: requesting to share a memory from a host operating system when it is monitored that software needs to share the memory in a guest operating system; allocating a memory share sub-region to the guest operating system by a Gralloc in the host operating system, and returning an index value of the memory share sub-region to the guest operating system; and returning an address of a mapping sub-region to the software upon mapping the memory share sub-region corresponding to the index value to the guest operating system by an QEMU. In this way, the multi-operating systems access the memory.

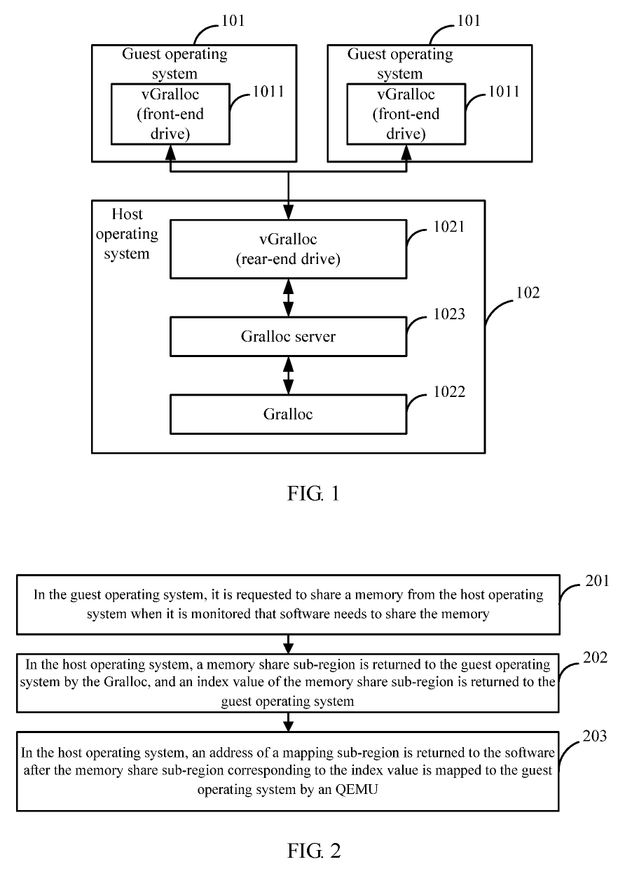

The memory access method for use in multi-operating systems according to the present application is applied to a system as illustrated in FIG. 1. The system includes a plurality of guest operating systems 101 and a host operating system 102. Each of the guest operating systems 101 includes a vGralloc and a front-end drive 1011, and the host operating system includes a rear-end drive 1021, a Gralloc 1022 and a Gralloc server 1023.

In the system as illustrated in FIG. 1, when any of the guest operating systems 101 accesses a physical continuous memory shared between all the guest operating systems 101 and the host operating system 102, the access may be practiced by the following process. Referring to FIG. 2, the process includes the following steps:

201: In the guest operating system, it is requested to share a memory from the host operating system when it is monitored that software needs to share the memory.

The software is software which needs to call a central processing unit to directly access the memory, for example, Camera Capture or video soft-coding.

Specifically, a memory share request is sent to the host operating system when it is monitored that the software needs to share the memory in the guest operating system.

For example, when any of the guest operating systems 101 monitors that the software needs to share the memory, the guest operating system 101 requests to share the same memory from the Gralloc server 1023 via communication between the front-end drive 1011 and the rear-end drive 1021 thereof.

202: In the host operating system, a memory share sub-region is returned to the guest operating system by the Gralloc, and an index value of the memory share sub-region is returned to the guest operating system.

Specifically, upon receiving the memory share request via the rear-end drive 1021, the host operating system 102 requests the Gralloc server 1023 to call the Gralloc 1022 to allocate the memory share sub-region to any of the guest operating systems 101. The host operating system 102 returns the index value corresponding to the memory share sub-region to any of the guest operating systems via communication between the front-end drive 1011 and the rear-end drive 1021.

After the memory share sub-region is allocated to any of the guest operating systems 101 through step 201 and step 202, virtualization of the Gralloc 1022 is implemented.

203: In the host operating system, an address of a mapping sub-region is returned to the software after the memory share sub-region corresponding to the index value is mapped to the guest operating system by an QEMU.

Specifically, any of the guest operating systems 101 sends the index value to the QEMU, the QEMU maps the memory share sub-region corresponding to the index value to any of the guest operating systems 101, and any of the guest operating system 101 returns thee address of the mapping sub-region to the software.

For example, the memory share sub-region is mapped to any of the guest operating systems 101 via the QEMU, and then the memory share sub-region which is mapped via the QEMU is mapped to a user space of any one of the guest operating systems 101 via a kernel of any of the guest operating systems 101. Any of the guest operating systems 101 returns the address of the memory share sub-region to the software. In this way, the mapping sub-region corresponding to the address is accessed by the software in any of the guest operating systems 101, and hence the memory share sub-region of the host operating system 102 is accessed.

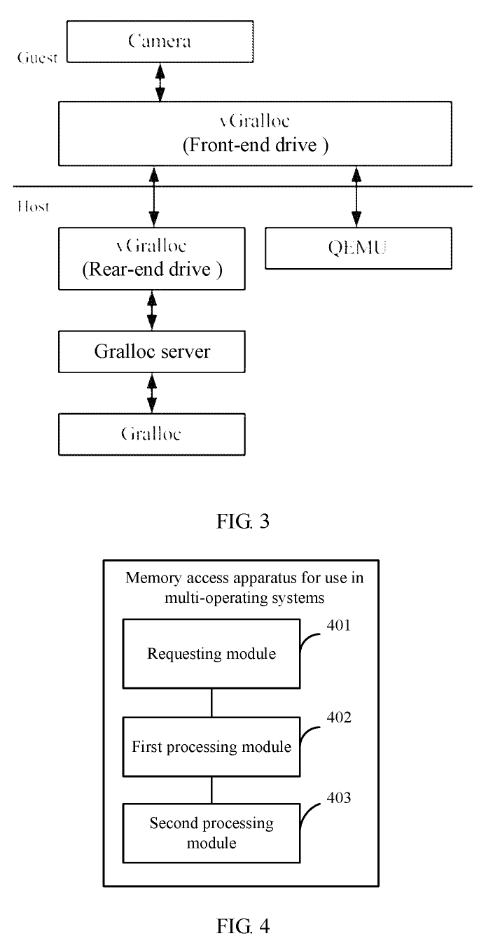

Using a shooting process as an example, memory access is practiced by using the method according to this embodiment as follows. Referring to FIG. 3, any of the guest operating systems 101 is a guest, and the host operating system 102 is a host. When a camera in the guest prepares to shoot pictures, a memory for sharing is requested from the Gralloc server of the host via communication between the front-end drive of the guest and the rear-end drive of the host. The Guest acquires the index value of the memory share sub-region via communication between the front-end drive and the rear-end drive of the Host. When the camera shoots pictures, the index value is firstly send to the host operating system of the camera, and the host operating system of the camera finds the corresponding memory share sub-region based on the index value. The camera fills data upon picture shooting to the local region via DMA, then the index value corresponding to the memory share sub-region is sent from the guest to the QEMU, and finally the QEMU maps the memory share sub-region corresponding to the index value to the guest operating system. In this way, the corresponding memory share sub-region is locked. Upon mapping the memory share sub-region to the user space, the guest returns the address of the mapping sub-region to the software. Software of the camera in the guest reads the data in the memory share sub-region via the CPU, and stores the data as a picture file.

Beneficial Effects:

According to the embodiment of the present application, it is requested to share a memory from the host operating system when it is monitored that software needs to share the memory in the guest operating system; a memory share sub-region is allocated to the guest operating system by a Gralloc in the host operating system, and an index value of the memory share sub-region us returned to the guest operating system; and an address of a mapping sub-region is returned to the software upon mapping the memory share sub-region corresponding to the index value to the guest operating system by an QEMU. In this way, the multi-operating systems access the memory.

Based on the same inventive concept, this embodiment provides a memory access apparatus for use in multi-operating systems. The memory access apparatus solves the problem based on the same principle as the memory access method as illustrated in FIG. 2. Therefore, practice of the memory access apparatus for use in multi-operating systems may be referenced to the practice of the memory access method for use in multi-operating systems as illustrated in FIG. 2, and the repeated content is not described herein any further.

As illustrated in FIG. 4, the memory access apparatus for use in multi-operating systems includes:

a requesting module 401, configured to request to share a memory from a host operating system when it is monitored that software needs to share the memory in a guest operating system;

a first processing module 402, configured to allocate a memory share sub-region to the guest operating system by a memory share management module Gralloc in the host operating system, and return an index value of the memory share sub-region to the guest operating system; and

a second processing module 403, configured to return an address of a mapping sub-region to the software upon mapping the memory share sub-region corresponding to the index value to the guest operating system by an emulation processor QEMU.

Optionally, the requesting module 401 is further configured to send a memory share request to the host operating system when it is monitored that the software needs to share the memory in the guest operating system.

Optionally, the software is software which needs to call a central processing unit to directly access the memory.

Beneficial Effects:

According to the embodiment of the present application, it is requested to share a memory from the host operating system when it is monitored that software needs to share the memory in the guest operating system; a memory share sub-region is allocated to the guest operating system by a Gralloc in the host operating system, and an index value of the memory share sub-region us returned to the guest operating system; and an address of a mapping sub-region is returned to the software upon mapping the memory share sub-region corresponding to the index value to the guest operating system by an QEMU. In this way, the multi-operating systems access the memory.

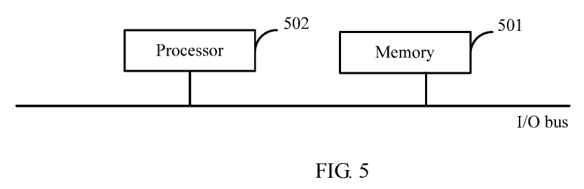

In a still another aspect, an embodiment of the present application further provides an electronic device. Referring to FIG. 5, the electronic device includes:

A memory 501, and at least one processor 502; wherein the memory is communicably connected to the at least one processor via a communication bus; the at least one processor is configured to perform instructions stored in the memory; and the memory stores instructions for performing all the steps in the memory access method for use in multi-operating systems according to any one of the above embodiments.

In yet still another aspect, an embodiment of the present application further provides a computer program product for use in combination with the electronic device. The computer program product includes a computer program embedded into a computer-readable storage medium; wherein the computer program includes instructions for causing the electronic device to perform all the steps in the memory access method for use in multi-operating systems according to any one of the above embodiments.

Those skilled in the art shall understand that the embodiments of the present application may be described as illustrating methods, systems, or computer program products. Therefore, hardware embodiments, software embodiments, or hardware-plus-software embodiments may be used to illustrate the present application. In addition, the present application may further employ a computer program product which may be implemented by at least one non-transitory computer-readable storage medium with an executable program code stored thereon. The non-transitory computer-readable storage medium includes but not limited to a disk memory, a CD-ROM, and an optical memory.

The present application is described based on the flowcharts and/or block diagrams of the method, device (system), and computer program product. It should be understood that each process and/or block in the flowcharts and/or block diagrams, and any combination of the processes and/or blocks in the flowcharts and/or block diagrams may be implemented using computer program instructions. These computer program instructions may be issued to a computer, a dedicated computer, an embedded processor, or processors of other programmable data processing device to generate a machine, which enables the computer or the processors of other programmable data processing devices to execute the instructions to implement an apparatus for implementing specific functions in at least one process in the flowcharts and/or at least one block in the block diagrams.

These computer program instructions may also be stored a non-transitory computer-readable memory capable of causing a computer or other programmable data processing devices to work in a specific mode, such that the instructions stored on the non-transitory computer-readable memory implement a product including an instruction apparatus, wherein the instruction apparatus implements specific functions in at least one process in the flowcharts and/or at least one block in the block diagrams.

These computer program instructions may also be stored on a computer or other programmable data processing devices, such that the computer or the other programmable data processing devices execute a series of operations or steps to implement processing of the computer. In this way, the instructions, when executed on the computer or the other programmable data processing devices, implement the specific functions in at least one process in the flowcharts and/or at least one block in the block diagrams.

Although the preferred embodiments of the present application are described above, once knowing the basic creative concept, a person skilled in the art can make other modifications and variations to these embodiments. Therefore, the appended claims are intended to be construed as covering the preferred embodiments and all the modifications and variations falling within the scope of the present application.

What is claimed is:

1. A memory access method for use in multi-operating systems, comprising:
in a guest operating system, requesting to share a memory from a host operating system when it is monitored that software needs to share the memory;
in the host operating system, allocating a memory share sub-region to the guest operating system by a memory share management module Gralloc;
in the host operating system, returning an index value of the memory share sub-region to the guest operating system; and
in the guest operating system, returning an address of a mapping sub-region to the software upon mapping the memory share sub-region corresponding to the index value to the guest operating system by an emulation processor QEMU.

2. The method according to claim 1, wherein the in the guest operating system, requesting to share the memory from the host operating system when it is monitored that software needs to share the memory comprises:
in the guest operating system, sending a memory share request to the host operating system when it is monitored that the software needs to share the memory.

3. The method according to claim 1, wherein the software is software which needs to call a central processing unit to directly access the memory.

4. The method according to claim 1, wherein the in the guest operating system, requesting to share the memory from the host operating system when it is monitored that software needs to share the memory comprises:
in the guest operating system, when it is monitored that the software needs to share the memory, requesting to share the same memory from a Gralloc server in the host operating system via communication between a front-end drive in the guest operating system and a rear-end drive in the host operating system.

5. The method according to claim 4, wherein the in the host operating system, allocating the memory share sub-region to the guest operating system by the memory share management module Gralloc comprises:
in the host operating system, upon receiving the memory share request via the rear-end drive, requesting the Gralloc server to call the Gralloc to allocate the memory share sub-region to the guest operating system.

6. The method according to claim 4, wherein the in the host operating system, returning the index value of the memory share sub-region to the guest operating system comprises:
in the host operating system, returning the index value corresponding to the memory share sub-region to the guest operating system via communication between the front-end drive and the rear-end drive.

7. The method according to claim 4, wherein the mapping the memory share sub-region corresponding to the index value to the guest operating system by the emulation processor QEMU comprises:
mapping the memory share sub-region to the guest operating system via the QEMU; and
mapping the memory share sub-region which is mapped via the QEMU to a user space of the guest operating system via a kernel of the guest operating system.

8. An electronic device, comprising:
a memory, and at least one processor; wherein the memory is communicably connected to the at least one processor via a communication bus; the at least one processor is configured to perform instructions stored in the memory; and the memory stores instructions for performing the steps of:
in a guest operating system, requesting to share a memory from a host operating system when it is monitored that software needs to share the memory;
in the host operating system, allocating a memory share sub-region to the guest operating system by a memory share management module Gralloc;
in the host operating system, returning an index value of the memory share sub-region to the guest operating system; and
in the guest operating system, returning an address of a mapping sub-region to the software upon mapping the memory share sub-region corresponding to the index value to the guest operating system by an emulation processor QEMU.

9. The electronic device according to claim 8, wherein the in the guest operating system, requesting to share the memory from the host operating system when it is monitored that software needs to share the memory comprises:
in the guest operating system, sending a memory share request to the host operating system when it is monitored that the software needs to share the memory.

10. The electronic device according to claim 8, wherein the software is software which needs to call a central processing unit to directly access the memory.

11. The electronic device according to claim 8, wherein the in the guest operating system, requesting to share the memory from the host operating system when it is monitored that software needs to share the memory comprises:
in the guest operating system, when it is monitored that the software needs to share the memory, requesting to share the same memory from a Gralloc server in the host operating system via communication between a front-end drive in the guest operating system and a rear-end drive in the host operating system.

12. The electronic device according to claim 11, wherein the in the host operating system, allocating the memory share sub-region to the guest operating system by the memory share management module Gralloc comprises:
in the host operating system, upon receiving the memory share request via the rear-end drive, requesting the Gralloc server to call the Gralloc to allocate the memory share sub-region to the guest operating system.

13. The electronic device according to claim 11, wherein the in the host operating system, returning the index value of the memory share sub-region to the guest operating system comprises:
in the host operating system, returning the index value corresponding to the memory share sub-region to the guest operating system via communication between the front-end drive and the rear-end drive.

14. The electronic device according to claim 11, wherein the mapping the memory share sub-region corresponding to the index value to the guest operating system by the emulation processor QEMU comprises:
mapping the memory share sub-region to the guest operating system via the QEMU; and
mapping the memory share sub-region which is mapped via the QEMU to a user space of the guest operating system via a kernel of the guest operating system.

15. A computer program product for use in combination with an electronic device, comprising a computer program embedded into a computer-readable storage medium; wherein the computer program comprises instructions for causing the electronic device to perform the steps of:
in a guest operating system, requesting to share a memory from a host operating system when it is monitored that software needs to share the memory;
in the host operating system, allocating a memory share sub-region to the guest operating system by a memory share management module Gralloc;
in the host operating system, returning an index value of the memory share sub-region to the guest operating system; and
in the guest operating system, returning an address of a mapping sub-region to the software upon mapping the memory share sub-region corresponding to the index value to the guest operating system by an emulation processor QEMU.

16. The computer program product device according to claim 15, wherein the in the guest operating system, requesting to share the memory from the host operating system when it is monitored that software needs to share the memory comprises:
in the guest operating system, sending a memory share request to the host operating system when it is monitored that the software needs to share the memory.

17. The computer program product according to claim 15, wherein the software is software which needs to call a central processing unit to directly access the memory.

18. The computer program product according to claim 15, wherein the in the guest operating system, requesting to share the memory from the host operating system when it is monitored that software needs to share the memory comprises:
in the guest operating system, when it is monitored that the software needs to share the memory, requesting to share the same memory from a Gralloc server in the host operating system via communication between a front-end drive in the guest operating system and a rear-end drive in the host operating system.

19. The computer program product according to claim 18, wherein the in the host operating system, allocating the memory share sub-region to the guest operating system by the memory share management module Gralloc comprises:
in the host operating system, upon receiving the memory share request via the rear-end drive, requesting the Gralloc server to call the Gralloc to allocate the memory share sub-region to the guest operating system.

20. The computer program product according to claim 18, wherein the in the host operating system, returning the index value of the memory share sub-region to the guest operating system comprises:
in the host operating system, returning the index value corresponding to the memory share sub-region to the guest operating system via communication between the front-end drive and the rear-end drive.
